(19) United States
(12) Patent Application Publication
(10) Pub. No.: US 2014/0280365 A1
(43) Pub. Date: Sep. 18, 2014

(54) METHOD AND SYSTEM FOR DATA SYSTEM MANAGEMENT USING CLOUD-BASED DATA MIGRATION

(71) Applicant: UNISYS CORPORATION, Blue Bell, PA (US)

(72) Inventors: Nils Krugmann, Sulzbach (DE); Volker Menzfeld, Sulzbach (DE); David Howard, Uxbridge (GB)

(73) Assignee: UNISYS CORPORATION, Blue Bell, PA (US)

(21) Appl. No.: 13/800,049

(22) Filed: Mar. 13, 2013

(51) Int. Cl. G06F 17/30

(52) U.S. Cl. CPC G06F 17/3007
USPC 707/803

(57) ABSTRACT

A method and system for migrating data from a sender system located in an on-premise computing environment. The method includes importing by a receiver system located in a cloud-based computing environment coupled to the sender system via a network a program of data code and table structures exported from the sender system and transferred to the receiver system via the network. The method also includes importing by the receiver system at least one data flat file exported from the sender system and transferred to the receiver system via the network.

### BACKGROUND

1. Field

The instant disclosure relates generally to managing data systems within a computing environment, and more particularly, to managing data systems in a computing environment using cloud-based data migration.

2. Description of the Related Art

Due to limitations of conventional tools, the management of data systems, e.g., for testing and troubleshooting purposes, typically involves creating a complete copy of the productive system, including the entire data repository and all administrative settings, whether or not this information is required for testing purposes. Such methods duplicate the productive environment, and therefore is both relatively time-consuming and expensive in terms of infrastructure resources. However, nonproduction environments, such as development, testing and training, require specific data. Some conventional methods, such as the methods and processes involved in SAP's Test Data Migration Server (TDMS) software tool, addresses this need by allowing the selection of Just the amount of data that is needed.

The SAP TDMS tool uses rules to create an extract of the data that is approximately 30% the size of the complete data set, but still contains the data that is necessary to keep the business objects and processes consistent. The data sets can be reduced in several ways. A system shell can be created that contains only cross-client data and client-specific user and address data, but nothing else. Also, a system can be set up that contains only master data and customizing information. Alternatively, a nonproduction system car be created that contains master data, customizing information, and application data starting with a “defined from” date, in the “defined from” date scenario, some essential data may fall outside of the defined time period, but the nonproduction system still requires it. To handle this situation, SAP TDMS can include rules that logically link data, ensuring that all relevant information is transferred and that the consistency of the Involved business processes and data is maintained, even beyond the defined time period. The data sets also can be reduced based on organizational structure, such as company code or plant. Also, there are alternative ways to reduce data sets or custom scrambling routines for sensitive data.

However, despite the conventional efforts of SAP TDMS, all functions and processes are performed within the data center. That is, the cloned data used for testing and other purposes remains in the same data center as the original data.

### SUMMARY

Disclosed is a method and system for migrating data from a sender system located in an on-premise computing environment. The method includes importing by a receiver system located in a cloud-based computing environment coupled to the sender system via a network a program of data code and table structures exported from the sender system and transferred to the receiver system via the network. The method also includes importing by the receiver system at least one data flat file exported from the sender system and transferred to the receiver system via the network.

### BRIEF DESCRIPTION OF THE DRAWINGS

FIG. 1 is a schematic view of a conventional data migration architecture;

FIG. 2 is a schematic view of a data migration architecture, according to an embodiment;

FIG. 3 is a flow diagram of a method for managing data migration, according to an embodiment; and

FIG. 4 is a schematic diagram of a system for managing data migration, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

Today's business have several requirements or needs when implementing data management systems. One requirement or need is to reduce the footprint of nonproduction environments. A production environment is a system that supports the operations of an organization. Non-production environments are the systems used to develop and test the production systems prior to their deployment in production. Typically, these non-production environments would include some or all environments for development, test, training, sandbox (an environment to try new capabilities) and quality assurance.

Another requirement or need is to provide current data for development and test teams. Yet another requirement or need is to protect sensitive data in test and training systems. Still another requirement or need is to refresh data in non-production environments relatively quickly and efficiently. Yet another requirement or need is to enable functional teams to extract and transfer data for troubleshooting and testing purposes. Accordingly, businesses often consider implementing data management solutions that help to create and refresh relatively lean and consistent development, testing, quality assurance and training environments based on real business data.

One conventional data management system is SAP's Test Date Migration Server (TDMS) software tool. The SAP TDMS software is a high-speed data extraction tool that populates development, test (non-production), quality assurance and training systems with business data from the productive environment. The SAP TDMS reduces data volume, provides current data, allows the scrambling of data, eliminates sensitive data, automates and reduces the runtime of data refreshes, allows functional teams to transfer subsets of data, and reduces the workload of an already strained basis team.

FIG. 1 is a schematic view of a conventional data migration architecture 10, e.g., an SAP TDMS data migration tool. The data migration architecture 10 includes a production system 12, which includes original data 14 that is to be managed, e.g., testing or troubleshooting. The production system 12 also includes a cluster of scrambled data 16.

The architecture 10 also includes a data migration portion 18, such as an SAP TDMS environment. The data migration portion 18 of the architecture 10 can include a server 22, e.g., a TDMS server, for receiving from the production system 12 remote function coordinates (RFC) commands, table structures and other comparable data. The data migration portion 18 also receives data 24, e.g., in the form of one or more flat files, from the production system 12.

The architecture 10 also includes a (clone) test system 26. The test system 26 replicates the server and data storage environment of the data migration portion 18. For example, the test system 26 can include a server portion 28, which receives the RFC commands and tables structures from the server 22 in the data migration portion 18. The test system 26 also can include a scrambled data portion 32, which receives or stores the data received from the production system 12 via the data flat files from the data migration portion 18.

It should be noted that, in such a conventional data migration architecture 10, sensitive data does not leave the production system (PRD). Also, it should be noted that the data migration portion 18 can scramble data in cluster tables, as well as in flat files. Also, data migration environments, such as the SAP TDMS environment, can include a test data migration server manager (not shown), which allows remote connection to and interaction with the data migration sever. For example, the test data migration server manager can monitor and execute certain activities of the TDMS packages, receive alerts and updates, and view information for data throughput or system performance.

In conventional data migration architectures, the data migration portion 18 and the test system 22 are created and remain in the same location as the production system 12, i.e., the data migration portion 18 and the test system 22 are on-premise or remain in an on-premise computing environment. Although such configuration or arrangement can be beneficial in some respects, an on-premise test system environment can present certain issues.

For example, using on-premise systems for non-productive systems requires an organization to keep a pool of systems to support non-productive workloads. These environments require installation, setup and management costs, and are only used for short periods of time. For example, a development system can be used to prepare a new version of an SAP application, then the training and quality assurance (QA) systems are used to prepare the organization for the new release, but once the release is made these systems are only needed for light maintenance work. This variability of use means that for an individual organization it is difficult to optimize the use of non-production systems because they cannot easily share excess capacity with other organizations.

However, as will be described in greater detail hereinbelow, according to embodiments of the invention, if these non-production systems are migrated to a cloud-based computing environment, the cloud-based computing environment allows capacity to be shared between organizations, thereby improving system use and lowering the cost of providing non-production systems. If new equipment is required for the non-production environments in an on-premise installation, the installation of the new equipment might be delayed due to restrictions on capital expenditures (which implies a long term commitment to the expense). Such delay then leads to delays in the development and release of new versions of the SAP software.

When using a cloud-based computing environment according to embodiments of the invention, systems can be made available based on operational costs, which require relatively limited financial commitment. For development, testing and training these activities can be performed by external organizations or by employees working from outside the organizations premises if access to the non-production systems are enabled from outside the organization. Such arrangement and operation typically is complex to set-up for on-premise systems, but for a cloud-based computing environment, its normal mode of operation is to allow secure access to the cloud-based systems from multiple locations.

FIG. 2 is a schematic view of a data migration architecture 40, according to an embodiment. The data migration architecture 40 includes a local or on-premise portion or environment 42, and a remote or cloud-based portion or environment 44. The remote or cloud-based portion or environment 44 can be any suitable (off-premise) cloud-based computing environment that is operably coupled to the local or on-premise environment 42 via a suitable network or networks 45, such as the Internet. The use of computing resources (hardware and software) that are delivered as a service over a network (typically the Internet) often is referred to as “cloud computing.”

According to an embodiment, data migration architecture 40 facilitates the performance of a number of data migration functions as part of the data migration from the local or on-premise environment 42 to the remote or cloud-based environment 44. In general, a user exports a test system (or other data management system) and data files from an on-premise sender system 46, which is located in the local or on-premise environment 42, to a remote or off-premise receiver system (on demand receiver) 48, which is located in the cloud-based environment 44, via the network 45.

In addition to the on-premise sender system 46, the local or on-premise environment 42 can include other systems and/or components that can be coupled to the network 45. Such systems or components can include interfaces, other applications, and one or more on-premise users. Also, in addition to the remote or off-premise receiver system 48, the cloud-based environment 44 can include other systems and/or components that can be coupled to the network 45, such as one or more remote users.

The data migration from the on-premise sender system 46 to the off-premise receiver system 48 includes a number of phases or activities. In general, the phases function collectively to transport desired data to a repository in the receiver system 48 that should be the same as in the sender system 46. The phases or activities performed for the shell and data export and import of files include (1) a Shell Creation/Export phase 51 from the sender system 46, (2) a Data Export in Files phase 52 from the sender system 46, (3) a Transfer of Data Files phase 53, (4) a Shell Import phase 54 in the receiver system 48, and (5) a Data Import Through Files phase 55 in the receiver system 48.

The Shell Creation/Export phase 51 involves creating a new test landscape with a repository that is the same as the repository in the production system. For example, a training system is set up with a subset of data from the production system, with the newly set up repository being the same as the production system repository. The Shell Creation/Export phase 51 involves an R3 export, i.e., an export of program code and table structures. The Shell Creation/Export phase 51 is performed in the local or on-premise environment 42, from the on-premise sender system 48.

The Shell Creation/Export phase 51 provides a reduced data size being exported, as only the repository and cross client data is transferred. The reduced data size allows for a faster export operation, which provides affordable down time on the source system. Also the Shell Creation/Export phase 51 involves less hardware resources on the target system (e.g., disk space, CPU processing resources).

The Data Export in Files phase 52 involves creating an export package to copy data from the data cluster in the sender system 46 to multiple files in the transport directory of the source landscape. The Data Export in Files phase 52 involves a flat file export. The Data Export in Files phase 52 is performed in the local or on-premise environment 42, from the on-premise sender system 46.

The Data Export in Files phase 52 can involve setting up a quality assurance (QA) system that is located at a different location than the production system. Also, multiples non-production systems can be set up using the same set of export files.

The Data Export in Files phase 52 allows export data files to be copied into a different server or data storage disk drive to provide for receiver system to be set up at distant locations. The Data Export in Files phase 52 typically is carried out only once, although multiple non-production system can be setup.

The Transfer of Data Files phase 53 involves transferring the data files created in the Shell Creation/Export phase 51 (the R3 export files) and the data files created in the Data Export in Files phase 52 (the flat file export) from the sender system 46 in the on-premise environment 42 to the receiver system 48 in the cloud-based environment 44. The Transfer of Data Files phase 53 transfers the data files using any suitable file transfer protocol (FTP). Also, the Transfer of Data Files phase 53 can transfer the data using any suitable security technology (e.g., encryption) to protect the transferred data.

The Shell Import phase 54 involves importing the data files created by the Shell Creation/Export phase 51 (the R3 export files) in the on-premise environment 42 and transferred to the cloud-based environment 44 via the network 45. The Shell Import phase 54 involves creating a new system in the cloud-based environment 44 for importing the R3 files.

The Shell Import phase 54 includes a number of activities, including the preparation of the target operating system in the cloud-based environment 44. The Shell Import phase 54 also includes the transfer of the export R3 files and client 000 into the cloud-based environment 44. A system buildup with the data import follows. Also, a reference client is created and installation occurs. The Shell Import phase 54 also includes the performance of all necessary post activities, such as cleaning up User and Address data in the Shell system. Upon completion of the activities, a handover to the customer occurs.

The Data Import Through Files phase 55 involves importing the data files created by the Data Export in Files phase 52 (the flat file export) in the on-premise environment 42 and transferred to the cloud-based environment 44 via the network 45. The Data Import Through Files phase 55 involves creating an import package for importing the flat file to the receiver system 48.

FIG. 3 is a flow diagram of a method 60 for managing data migration, according to an embodiment. The method 60 includes a Shell Creation/Export step 62. As discussed hereinabove, the Shell Creation/Export step 62 creates a new test landscape with a repository the same as the repository in the production system, and prepares at least a subset of data from the production system for R3 off-premise export to the receiver system 48.

The method 60 also includes a Data Export in Files step 64. As discussed hereinabove, the Data Export in Files step 64 involves creating a flat file export package to copy data from the data cluster in the sender system 46 to multiple files in the transport directory of the source landscape. The flat file export package is used to prepare the data for export to the off-premise environment 44 and the receiver system 48.

The method 60 also includes a Transfer of Data Files step 68. As discussed hereinabove, the Transfer of Data Files step 66 involves transferring the R3 files created in the Shell Creation/Export step 62 and the data files created in the Data Export in Files step 64 from the sender system 48 in the on-premise environment 42 to the receiver system 48 in the cloud-based environment 44. The Transfer of Data Files step 66 transfers the data files using any suitable file transfer protocol.

The method 60 also includes a Shell Import step 68. As discussed hereinabove, the Shell Import step 68 involves importing the R3 export files created by the Shell Creation/Export step 62 and transferred to the cloud-based environment 44 via the network 45. The Shell Import step 68 includes creating a new system in the cloud-based environment 44 for the imported R3 files.

The method 60 also includes a Data Import Through Files step 72. As discussed hereinabove, the Data Import Through Files step 72 involves importing the flat file data files created by the Data Export in Files step 64 in the on-premise environment 42 and transferred to the cloud-based environment 44 via the network 45. The Data Import Through Files step 72 includes creating an import package for importing the flat file data files to the receiver system 48.

Although the methods and processes described herein are described with respect to TDMS applications, it should be understood that the methods and processes described herein are applicable to any system that can be offloaded and tested.

FIG. 4 is a schematic diagram of a system 80 for managing data migration, according to an embodiment. The system 80 includes one or more computing devices, such as a server 82, e.g., an on-demand TDMS server, for supporting data migration, according to an embodiment. The server 82 is coupled to the receiver system 48, and also can be coupled to the sender system (not shown) via the network 45.

The server 82 includes one or more general purpose (host) controllers or processors 84 that, in general, processes instructions, data and other information received by the server 82. The processor 84 also manages the movement of various instructional or informational flows between various components within the server 82. The processor 84 includes a data migration module 88 residing therein or coupled thereto. The data migration module 86 is configured to execute and perform one or more of the data migration steps described herein.

The server 82 also can include a memory element or content storage element 88, coupled to the processor 84, for storing instructions, data and other information received and/or created by the server 82. In addition to the memory element 86, the server 82 can include at least one type of memory or memory unit (not shown) within the processor 84 for storing processing instructions and/or information received and/or created by the server 82.

The server 82 also can include one or more user interfaces for receiving instructions, data and other information from the network 45. The server 82 also can include one or more interfaces for transferring data and other information to the receiver system 48. It should be understood that one or more of the interfaces can be a single input/output interface, or the server 82 can include separate input and output interfaces.

One or more of the processor 84, the data migration module 86, the memory element 88 and the interfaces can be comprised partially or completely of any suitable structure or arrangement, e.g., one or more integrated circuits. Also, it should be understood that the server 82 includes other components, hardware and software (not shown) that are used for the operation of other features and functions of the system 80 not specifically described herein.

The server 82 can be partially or completely configured in the form of hardware circuitry and/or other hardware components within a larger device or group of components. Alternatively, the processes performed by the server 82 can be partially or completely configured in the form of software, e.g., as processing instructions and/or one or more sets of logic or computer code. In such configuration, the logic or processing instructions typically are stored in a data storage device, e.g., the memory element 66 or other suitable data storage device (not shown). The data storage device typically is coupled to a processor or controller, e.g., the processor 84. The processor accesses the necessary instructions from the data storage element and executes the instructions or transfers the instructions to the appropriate location within the server 82.

At least a portion of the data migration module 86 can be implemented in software, hardware, firmware, or any combination thereof. In certain embodiments, the module(s) may be implemented in software or firmware that is stored in a memory and/or associated components and that are executed by the processor 84, or any other processor(s) or suitable instruction execution system. In software or firmware embodiments, the logic may be written in any suitable computer language. One of ordinary skill in the art will appreciate that any process or method descriptions associated with the data migration module 88 may represent modules, segments, logic or portions of code which include one or more executable instructions for implementing logical functions or steps in the process, it should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The functions described herein may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for migrating data from a sender system located in an on-premise computing environment, comprising:
importing by a receiver system located in a cloud-based computing environment coupled to the sender system via a network a program of data code and table structures exported from the sender system and transferred to the receiver system via the network; and
importing by the receiver system at least one data flat file exported from the sender system and transferred to the receiver system via the network.

2. The method as recited in claim 1, wherein the program of data code and table structures imported by the receiver system is created by a Shell Creation/Export phase in the on-premise computing environment.

3. The method as recited in claim 1, wherein the at least one data flat file imported by the receiver system is created by a Data Export in Files phase in the on-premise computing environment.

4. The method as recited in claim 1, wherein the program of data code and table structures imported by the receiver system is in the form of a repository that is the same as a repository in the on-premise computing environment.

5. The method as recited in claim 1, wherein importing the network a program of data code and table structures exported from the sender system includes creating a new system in the receiver system for importing the program of data code and table structures.

6. The method as recited in claim 1, wherein importing the at least one data flat file exported from the sender system includes creating an import package for importing the at least one data flat file.

7. The method as recited in claim 1, wherein at least one of the network a program of data code and table structures and the at least one data flat file is imported to the receiver system via a file transfer protocol (FTP).

8. A cloud-based environment data migration system, comprising:
a data migration server coupled to a sender located in an on-premise computing environment via a network, wherein the server is configured to import a program of data code and table structures exported from the sender system and transferred to the receiver system via the network, and configured to import at least one data flat file exported from the sender system and transferred to the receiver system via the network; and
a receiver system coupled to the server and configured to receive the program of data code and table structures imported to the data migration server and the at least one data flat file imported to the data migration server, wherein the receiver system also is configured to receive RFC commands from the data migration server.

9. The data migration system as recited in claim 8, wherein the program of data code and table structures imported by the data migration server is created by a Shell Creation/Export phase in the on-premise computing environment.

10. The data migration system as recited in claim 8, wherein the at least one data flat file imported by the data migration server is created by a Data Export in Files phase in the on-premise computing environment.

11. The data migration system as recited in claim 8, wherein the program of data code and table structures imported by the data migration server is in the form of a repository that is the same as a repository in the on-premise computing environment.

12. The data migration system as recited in claim 8, wherein importing the network a program of data code and table structures exported from the sender system includes creating a new system in the data migration server for importing the program of data code and table structures.

13. The data migration system as recited in claim 8, wherein importing the at least one data flat file exported from the sender system includes creating an import package for importing the at least one data flat file.

14. A data migration system, comprising:
a sender system located in an on-premise computing environment; and
a receiver system located in a cloud-based computing environment and coupled to the sender system via a network,
wherein the sender system is configured to export a program of data code and table structures to the receiver system via the network,
wherein the sender system is configured to export at least one data flat file to the receiver system via the network,
wherein the receiver system is configured to import the program of data code and table structures exported from the sender system via the network, and
wherein the receiver system is configured to import the at least one data flat file exported from the sender system via the network.

15. The data migration system as recited in claim 14, wherein the sender system exports the program of data code and table structures by a Shell Creation/Export phase in the on-premise computing environment.

16. The data migration system as recited in claim 14, wherein the sender system exports the at least one data flat file by a Data Export in Files phase in the on-premise computing environment.

17. The data migration system as recited in claim 14, wherein the program of data code and table structures imported by the receiver system is in the form of a repository that is the same as a repository in the on-premise computing environment.

18. The data migration system as recited in claim 14, wherein importing the network a program of data code and table structures exported from the sender system includes the receiver system creating a new system in the receiver system for importing the program of data code and table structures.

19. The data migration system as recited in claim 14, wherein importing the at least one data flat file exported from the sender system includes the receiver system creating an import package for importing the at least one data flat file.
